(19) United States
(12) Patent Application Publication
(10) Pub. No.: US 2025/0053144 A1
(43) Pub. Date: Feb. 13, 2025

(54) CONTINUOUS PRODUCTION PROCESS OPTIMIZATION USING MACHINE LEARNING

(71) Applicant: International Business Machines Corporation, Armonk, NY (US)

(72) Inventors: Jing Du, Beijing (CN); Deng Xin Luo, Xian (CN); Li Jia Lu, Xian (CN); Miao Guo, Beijing (CN)

(21) Appl. No.: 18/231,657

(22) Filed: Aug. 8, 2023

(51) Int. Cl. G05B 13/04; G05B 13/02

(52) U.S. Cl. CPC G05B 13/048; G05B 13/027

(57) ABSTRACT

One embodiment of the invention provides a computer-implemented method for optimization of a continuous production process. The method comprises receiving input data comprising a plurality of datasets each including one or more variables relating to a production equipment involved in the continuous production process. The method further comprises generating different prediction models based on the input data. Each of the prediction models is configured to output a target prediction relating to the production equipment. The method further comprises generating an objective optimization model based on each target prediction output from each of the prediction models. The objective optimization model comprises a deep neural network. The method further comprises generating a loss function corresponding to the objective optimization model, and optimizing weights for parameters of the prediction models using backpropagation of the deep neural network and the loss function, resulting in optimized weights for the parameters of the prediction models.

### BACKGROUND

The field of embodiments of the invention generally relate to continuous production.

In manufacturing, a continuous production process (or system) is a type of production method (or production system) used by manufacturing, production, or processing companies to manufacture, produce, or process a very large volume of products or materials in a consistent, constant, and uninterrupted manner. Continuous production processes are typically used in the manufacturing, production, or processing of chemicals, drugs, glass, crude oil, cement, etc. Continuous production processes use a large amount of specialized production equipment (or machinery) and production equipment dedicated to specific tasks, and software programs and complex equipment may also be used to collect feedback from different production equipment to regulate the rate of flow and control the rate of production.

### SUMMARY

Embodiments of the invention generally relate to continuous production processes, and more specifically, optimization of a continuous production process based on backpropagation of a deep neural network.

One embodiment of the invention provides a computer-implemented method for optimization of a continuous production process. The computer-implemented method comprises receiving input data comprising a plurality of datasets each including one or more variables relating to a production equipment involved in the continuous production process. The method further comprises generating different prediction models based on the input data. Each of the different prediction models is configured to output a target prediction relating to the production equipment. The computer-implemented method further comprises generating an objective optimization model based on each target prediction output from each of the different prediction models. The objective optimization model comprises a deep neural network. The computer-implemented method further comprises generating a loss function corresponding to the objective optimization model, and optimizing a plurality of weights for a plurality of parameters of the different prediction models using backpropagation of the deep neural network and the loss function, resulting in a plurality of optimized weights for the parameters of the different prediction models. Other embodiments include a system for optimization of a continuous production process, and a computer program product for optimization of a continuous production process.

### BRIEF DESCRIPTION OF THE DRAWINGS

The subject matter which is regarded as embodiments of the invention are particularly pointed out and distinctly claimed in the claims at the conclusion of the specification. The foregoing and other objects, features, and advantages of embodiments of the invention are apparent from the following detailed description taken in conjunction with the accompanying drawings in which:

FIG. 1 depicts a computing environment according to an embodiment of the present invention;

FIG. 2 illustrates an example continuous production optimization system for optimization of a continuous production process based on backpropagation of a deep neural network, in accordance with an embodiment of the invention;

FIG. 3 illustrates an example deep neural network for optimization of a continuous production process based on backpropagation of the deep neural network, in accordance with an embodiment of the invention; and

FIG. 4 is a flowchart for an example process for optimization of a continuous production process based on backpropagation of a deep neural network, in accordance with an embodiment of the invention.

The detailed description explains the preferred embodiments of the invention, together with advantages and features, by way of example with reference to the drawings.

### DETAILED DESCRIPTION

Embodiments of the invention generally relate to continuous production processes, and more specifically, optimization of a continuous production process based on backpropagation of a deep neural network. One embodiment of the invention provides a computer-implemented method for optimization of a continuous production process. The computer-implemented method comprises receiving input data comprising a plurality of datasets each including one or more variables relating to a production equipment involved in the continuous production process. In some embodiments, each dataset refers to a respective different production equipment and/or to a respective different portion of a single production equipment. The method further comprises generating different prediction models based on the input data. In some embodiments, a respective prediction model is generated for each of the datasets. Each of the different prediction models is configured to output a target prediction relating to the production equipment. The computer-implemented method further comprises generating an objective optimization model based on each target prediction output from each of the different prediction models. The objective optimization model comprises a deep neural network. The computer-implemented method further comprises generating a loss function corresponding to the objective optimization model, and optimizing a plurality of weights for a plurality of parameters of the different prediction models using backpropagation of the deep neural network and the loss function, resulting in a plurality of optimized weights for the parameters of the different prediction models.

Another embodiment of the invention provides a system for optimization of a continuous production process. The system comprises at least one processor and a processor-readable memory device storing instructions that when executed by the at least one processor causes the at least one processor to perform operations. The operations include receiving input data comprising a plurality of datasets each including one or more variables relating to a production equipment involved in the continuous production process. In some embodiments, each dataset refers to a respective different production equipment and/or to a respective different portion of a single production equipment. The operations further include generating different prediction models based on the input data. In some embodiments, a respective prediction model is generated for each of the datasets. Each of the different prediction models is configured to output a target prediction relating to the production equipment. The operations further include generating an objective optimization model based on each target prediction output from each of the different prediction models. The objective optimization model comprises a deep neural network. The operations further include generating a loss function corresponding to the objective optimization model, and optimizing a plurality of weights for a plurality of parameters of the different prediction models using backpropagation of the deep neural network and the loss function, resulting in a plurality of optimized weights for the parameters of the different prediction models.

One embodiment of the invention provides a computer program product for optimization of a continuous production process, the computer program product comprising a computer readable storage medium having program instructions embodied therewith. The program instructions executable by a processor to cause the processor to receive input data comprising a plurality of datasets each including one or more variables relating to a production equipment involved in the continuous production process. In some embodiments, each dataset refers to a respective different production equipment and/or to a respective different portion of a single production equipment. The program instructions are executable by the processor to further cause the processor to generate different prediction models based on the input data. In some embodiments, a respective prediction model is generated for each of the datasets. Each of the different prediction models is configured to output a target prediction relating to the production equipment. The program instructions are executable by the processor to further cause the processor to generate an objective optimization model based on each target prediction output from each of the different prediction models. The objective optimization model comprises a deep neural network. The program instructions are executable by the processor to further cause the processor to generate a loss function corresponding to the objective optimization model, and optimize a plurality of weights for a plurality of parameters of the different prediction models using backpropagation of the deep neural network and the loss function, resulting in a plurality of optimized weights for the parameters of the different prediction models.

In at least some embodiments, the datasets are split between a first group of datasets for training and a second group of datasets for testing, a problem type for each of the different prediction models is defined, a machine-learning algorithm for training each of the different prediction models is selected, and one or more statistical measures for evaluating performance of each the different prediction models are selected. Each statistical measure selected is an important indicator of the continuous production process (i.e., indicates accuracy of the different prediction models and quality of production).

In at least some embodiments, the datasets include different variables with different time ranges that correspond to the different prediction models.

In at least some embodiments, the optimized weights for the parameters of the different prediction models are provided as output.

In at least some embodiments, the different prediction models with fixed parameters based on the optimized weights are provided as output.

In at least some embodiments, an objective function corresponding to the objective optimization model is generated, and constraints corresponding to the objective optimization model are generated. The objective function represents one or more production optimization goals. The constraints are used to maintain the performance of each of the different prediction models.

In at least some embodiments, the objective optimization model is trained to minimize a difference quantified by the loss function. The difference is between an expected objective value and a predicted objective value, where the expected objective value is based on the objective function, and the predicted objective value is output from the objective optimization model.

In at least some embodiments, an input layer of the deep neural network propagates initial weight matrices representing configurations of the different prediction models.

Some conventional continuous production processes generally rely on industry experts with production experience for adjustment of control parameters of production equipment. Specifically, these industry experts manually make real-time adjustments to the control parameters based on feedback to improve energy efficiency and ensure quality of production. In some other conventional production processes, specific optimization models may be leveraged to convert production experience of industry experts into machine learning models, thereby reducing consumption of human resources (i.e., reducing reliance on industry experts) and improving timeliness and accuracy of forecasts. However, these conventional optimization models cannot easily, accurately, and fully capture dependencies between prediction models as well as relationships (i.e., connections) between production optimization goals (i.e., objectives) and control parameters of production equipment. Further, these conventional optimization models require large usage limitations on time range and types of production processes. For example, these conventional optimization models may utilize brute force search to determine which control parameters of production equipment cause prediction models to output target predictions that incur penalty values when compared against production optimization goals.

A deep neural network is an artificial neural network with multiple hidden layers between the input and output layers. Deep neural networks can model complex non-linear relationships.

One or more embodiments of the invention provide a framework for optimization of a continuous production process based on backpropagation of a deep neural network. In some embodiments, backpropagation through the neural network is used to correlate results of important indicators of the continuous production process with production optimization goals (i.e., objectives). With the framework, relationships (i.e., connections) between control parameters of production equipment and the production optimization goals are tightened while accuracy of prediction models are ensured, thereby accelerating and improving optimization of the continuous production process. Multi-target analysis of various inputs affecting a continuous production process are analyzed and optimized.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

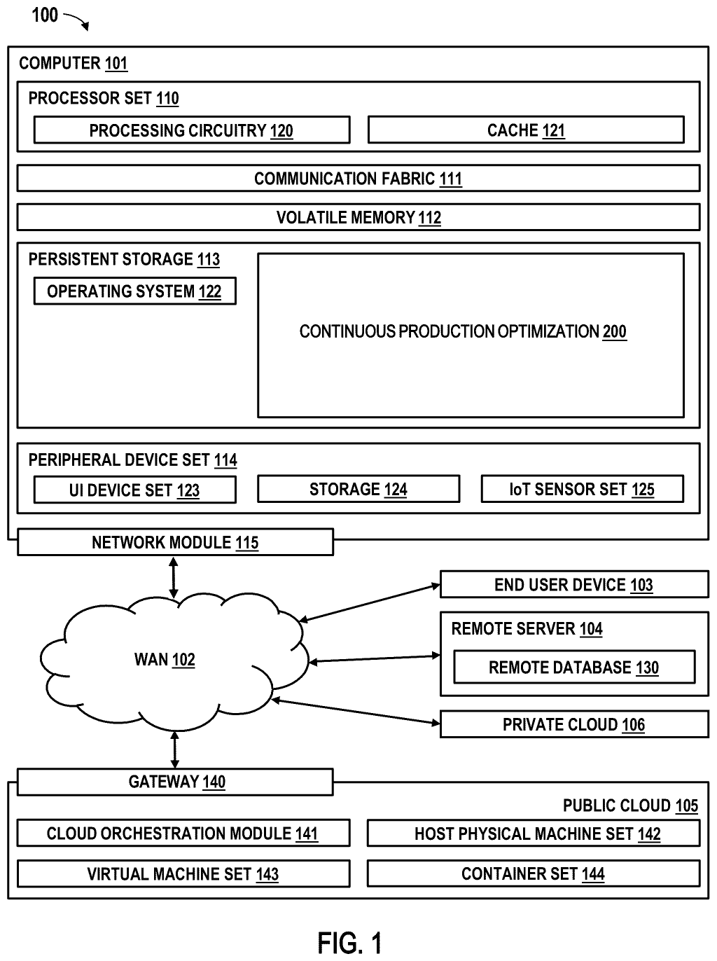

FIG. 1 depicts a computing environment 100 according to an embodiment of the present invention. Computing environment 100 contains an example of an environment for the execution of at least some of the computer code involved in performing the inventive methods, such as a continuous production optimization code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

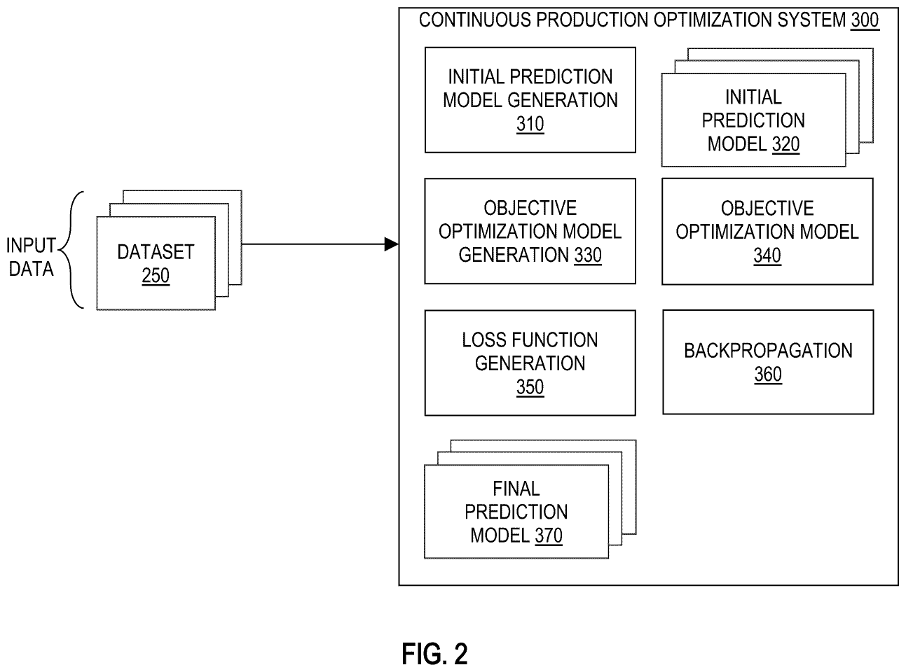

FIG. 2 illustrates an example continuous production optimization system 300 for optimization of a continuous production process based on backpropagation of a deep neural network, in accordance with an embodiment of the invention. The system 300 may be used to optimize a continuous production process involving different production equipment. In some embodiments, the system 300 is representative of the block 200 shown in FIG. 1.

In some embodiments, the system 300 is configured to receive input data comprising one or more datasets 250. Each dataset 250 corresponds to an initial prediction model 320 for multiple target variable classification, and the dataset 250 represents a configuration of the initial prediction model 320. For example, in some embodiments, a dataset 250 comprises, but is not limited to, at least one control variable for a corresponding initial prediction model 320, at least one other variable for the corresponding initial prediction model 320, etc. In some embodiments, a control variable represents a control parameter of a production equipment involved in the continuous production process. In some embodiments, each dataset 250 refers to a respective different production equipment and/or to a respective different portion of a single production equipment. In some embodiments, the input data is received via a data transmission over a network, for example via the computer 101 shown in FIG. 1 receiving one or more data files transmitted from another computer via the WAN 102 shown in FIG. 1. In some embodiments, the input data is received via a local data transmission, e.g., from a portable computer readable storage medium inserted directly into the computer 101.

In some embodiments, the system 300 comprises an initial prediction model generation unit 310 configured to: (1) receive, as input, a plurality of datasets 250 corresponding to individual different initial prediction models 320, (2) split the plurality of datasets 250 between a first group of datasets 250 for training and a second group of datasets 250 for testing, (3) define a problem type for each initial prediction model 320, (4) select a machine-learning algorithm for training each initial prediction model 320, (5) select one or more statistical measures for evaluating performance of each initial prediction model 320, and (6) generate (i.e., build or construct) the different initial prediction models 320 based on the plurality of datasets 250, the problem type, the machine-learning algorithm, and the one or more statistical measures. For example, in some embodiments, the different initial prediction models 320 include a first initial prediction model 320, a second initial prediction model 320, . . . , and a m^{th} initial prediction model 320, wherein m is a positive integer. In some embodiments, a respective initial prediction model is generated for each of the datasets 250.

In some embodiments, the plurality of datasets 250 include different variables (i.e., control variables and other variables) with different time ranges that correspond to the different initial prediction models 320. In some embodiments, the different initial prediction models 320 are trained and tested using the first group of datasets 250 and the second group of datasets 250, respectively.

In some embodiments, the selection of a machine-learning algorithm for training each initial prediction model 320 and the selection of one or more statistical measures for evaluating performance of each initial prediction model 320 occurs via a respective selection, i.e., so that a unique selection is made for each of the separate initial prediction models 320. In other words, the machine-learning algorithms selected are different or the same for the different initial prediction models 320, and the one or more statistical measures selected are different or the same for the different initial prediction models 320.

Examples of machine-learning algorithms that may be selected include, but are not limited to, XGBoost, linear regression algorithms, Naïve Bayes classification algorithms, ordinary least squares regression algorithms, clustering algorithms, decision tree algorithms, logistic regression algorithms, etc. Examples of statistical measures that may be selected include, but are not limited to, mean absolute percentage error (MAPE), R-squared (R² or coefficient determination), etc. Each statistical measure selected is an important indicator of the continuous production process (i.e., indicates accuracy of the different initial prediction models 320 and quality of production).

In some embodiments, the selection of the respective machine-learning algorithm and/or the one or more statistical measures via the initial prediction model generation unit 310 occurs in an automated manner, e.g., via a machine learning model, based on the type(s) of the initial prediction models 320. This machine learning model may be trained in a supervised, unsupervised, or semi-supervised manner using training data of a type of an initial prediction model 320 accompanied with an appropriate machine learning algorithm and/or one or more statistical measures for evaluating the initial prediction model 320. In some embodiments, the selection of the respective machine-learning algorithm and/or the one or more statistical measures occurs via a technician who inputs the selection into a computer such as the computer 101 shown in FIG. 1 to access the initial prediction model generation unit 310.

In some embodiments, the selection of the respective machine-learning algorithm and/or the one or more statistical measures occurs in a semi-automated manner in which a machine learning algorithm of the initial prediction model generation unit 310 suggests, via a visible and/or audible presentation of the suggestion via the computer 101 shown in FIG. 1, a respective machine-learning algorithm and/or the one or more statistical measures that would be appropriate and a technician is able to confirm or reject the suggestion via responsive input to the initial prediction model generation unit 310 using an input device connected to and/or communicating with the computer 101.

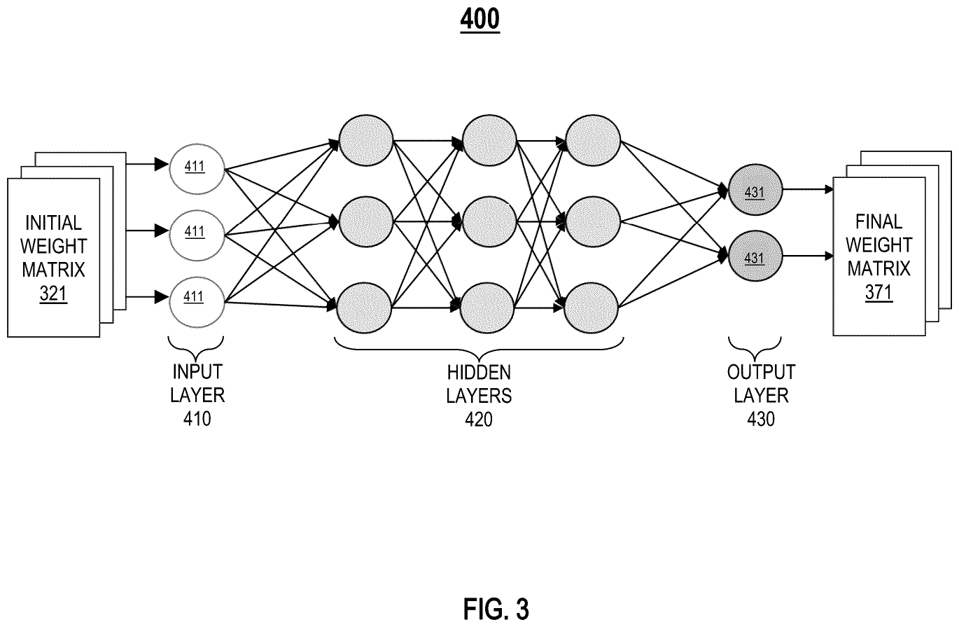

Each initial prediction model 320 has a corresponding initial weight matrix 321 (FIG. 3) comprising weights for different parameters of the initial prediction model 320. In some embodiments, initial weight matrices 321 corresponding to the different initial prediction models 320 are determined based on the plurality of datasets 250. Each initial prediction model 320 is configured to provide, as output, a target prediction relating to a production equipment involved in the continuous production process.

In some embodiments, the system 300 comprises an objective optimization model generation unit 330 configured to: (1) receive each target prediction provided as output from each initial prediction model 320, and (2) generate, based on each target prediction received, an objective optimization model 340, wherein each target prediction received is an input variable of the model 340. In some embodiments, generating an objective optimization model 340 includes generating an objective function corresponding to the model 340, and further generating constraints corresponding to the model 340. An objective function represents one or more production optimization goals (i.e., objectives).

In some embodiments, an objective function corresponding to an objective optimization model 340 is represented in accordance with equation (1) provided below:

$$min {\sum }_{i = 1}^{m} {Conf}_{i} * {PreModel}_{i} , \qquad ( 1 )$$

wherein Confᵢ are cost coefficients for an i^{th} initial prediction model 320, m is the total number of initial prediction models 320, and PreModelᵢ is a target prediction provided as output from the i^{th} initial prediction model 320.

For example, in some embodiments, the different initial prediction models 320 include, but are not limited to, a first prediction model 320 referenced as A with cost coefficients a, a second prediction model 320 referenced as B with cost coefficients b, a third prediction model 320 referenced as C with cost coefficients c, a fourth prediction model 320 referenced as D with cost coefficients d, and a fifth prediction model 320 referenced as E with cost coefficients e. An objective function corresponding to an objective optimization model 340 may be represented in accordance with equation (2) provided below:

$$a * {PreModel}_{A} + b * {PreModel}_{B} + c * {PreModel}_{C} + d * {PreModel}_{D} + e * {PreModel}_{E} + … . \qquad ( 2 )$$

In some embodiments, constraints corresponding to an objective optimization model 340 are based on a threshold for each initial prediction model 320, such that each target prediction provided as output from each initial prediction model 320 is compared against the threshold. In some embodiments, the threshold is used to maintain performance of each initial prediction model 320. For example, in some embodiments, the threshold and/or the constraints are based on one or more statistical measures selected (e.g., via the initial prediction model generation unit 310) for evaluating performance of each initial prediction model 320 such as, but not limited to, MAPE, R², etc.

In some embodiments, constraints corresponding to an objective optimization model 340 are represented in accordance with equation (3) provided below:

$${\sum }_{i = 1}^{m} {PreModel}_{i} \geq threshold , \qquad ( 3 )$$

wherein threshold is a threshold for each initial prediction model 320, and each target prediction provided as output from each initial prediction model 320 must be greater than or equal to threshold.

In some embodiments, an objective optimization model 340 generated (e.g., by the objective optimization model generation unit 330) comprises a deep neural network 400 (FIG. 3). As described in detail later herein, an input layer 410 (FIG. 3) of the neural network 400 receives, as input, initial weight matrices 321 (FIG. 3) corresponding to different initial prediction models 320, and an output layer 430 (FIG. 3) of the neural network 400 provides, as output, final weight matrices 371 (FIG. 3) corresponding to different final prediction models 370.

A loss function is used to optimize the objective optimization model 340. Let y denote an expected (i.e., estimated or target) objective value, wherein y is a real value. Let y′ denote a predicted objective value, wherein the predicted objective value y′ is an actual output of an objective optimization model 340. The current optimization model 340 will have a model output objective value for y′. Let ƒ(y,y′) denote a loss function with an expected objective value y and a predicted objective value y′ as input parameters.

In some embodiments, the system 300 comprises a loss function generation unit 350 configured to: (1) determine an expected objective value y, wherein the expected objective value y is based on an objective function corresponding to an objective optimization model 340, (2) receive a predicted objective value y′ from the objective optimization model 340, and (3) generate a loss function ƒ(y,y′) corresponding to the objective optimization model 340.

In some embodiments, an expected objective value y is determined in accordance with equation (4) provided below:

$$y = {y}_{last} * ( 1 + Percentage ) , \qquad ( 4 )$$

wherein yₗₐₛₜ is a last/prior objective value, and Percentage is a percentage of increase or decrease. For example, Percentage may be a percentage of increase in the amount of 20%. In some embodiments, an initial expected objective value is set up based on the increase or decrease of percentage rather than the old or last/prior objective value.

In some embodiments, a loss function ƒ(y,y′) includes a mean squared error (MSE) of input parameters y and y′ (i.e., the average squared difference between an expected objective value y and an actual objective value y′) and/or an absolute value of a difference between input parameters y and y′ (i.e., |y−y′|). In other embodiments, another type of a loss function is implemented.

As described in detail later herein, the system 330 performs a comparison of an expected objective value y and a predicted objective value y′ in accordance with a loss function ƒ(y,y′), and based on the comparison, trains the objective optimization model 340. Therefore, the loss function quantifies a difference (i.e., error rate/loss) between the expected objective value y and predicted objective value y′, and the objective optimization model 340 is trained to minimize the difference.

Backpropagation and forward propagation are different processes of propagating data through neural network layers of a neural network (e.g., neural network 400 in FIG. 3). Specifically, forward propagation is propagation of data through a neural network from input nodes of an input layer (e.g., input nodes 411 of input layer 410 in FIG. 3) to output nodes of an output layer (e.g., output nodes 431 of output layer 430 in FIG. 3). Backpropagation (or backward propagation of errors) is propagation of data through a neural network from output nodes of an output layer (e.g., output nodes 431 of output layer 430 in FIG. 3) to input nodes of an input layer (e.g., input nodes 411 of input layer 410 in FIG. 3).

In some embodiments, the system 300 comprises a backpropagation unit 360 configured to adjust (i.e., fine-tune) or optimize initial weight matrices 321 (FIG. 3) corresponding to different initial prediction models 320 using backpropagation of the neural network 400 (FIG. 3) of the objective optimization model 340. Specifically, the backpropagation unit 360 trains the neural network 400 by taking an error rate/loss (e.g., quantified by the loss function) of forward propagation through neural network layers of the neural network 400, and feeding this error rate/loss backward through the neural network layers of the neural network 400 (i.e., from output nodes 431 of the output layer 430 to input nodes 411 of the input layer 410 in FIG. 3). As a result of backpropagation of the neural network 400, the objective optimization model 340 provides, as output, final weight matrices 371 (FIG. 3) corresponding to different final prediction models 370. Each final prediction model 370 has a corresponding final weight matrix 371 comprising adjusted or optimized weights for different parameters of the final prediction model 370.

A final prediction model 370 is an adjusted or optimized version of an initial prediction model 320. Specifically, a final weight matrix 371 (FIG. 3) corresponding to the final prediction model 370 comprises adjusted or optimized weights that differ from those included in an initial weight matrix 321 (FIG. 3) corresponding to the initial prediction model 320.

In some embodiments, the system 300 automatically generates and provides, as output, the different final prediction models 370, wherein the different final prediction models 370 have fixed parameters based on the corresponding final weight matrices 371 (FIG. 3).

The system 300 accelerates the optimization process of finding the optimal value of the objective function using backpropagation. The system 300 uses backpropagation through the neural network 400 to build connections between the objective optimization model 340 and the different initial prediction models 320 to increase impact of a production optimization goal (defined by the objective function) on the different initial prediction models 320. The system 300 automatically generates (i.e., builds or constructs) the different final prediction models 370 based on the corresponding final weight matrices 371 (FIG. 3). Using the objective optimization model 340 to help optimize the individual different prediction models helps capture dependencies between the prediction models and better reflects correct relationships between the optimization objectives and the control parameters.

FIG. 3 illustrates an example deep neural network layer 400 for optimization of a continuous production process based on backpropagation of the deep neural network 400, in accordance with an embodiment of the invention. In some embodiments, the objective optimization model 340 comprises a deep neural network layer 400. The neural network 400 comprises a plurality of neural network layers including: (1) an input layer 410 comprising input nodes 411, (2) one or more hidden layers 420, and (3) an output layer 430 comprising output nodes 431. The input nodes 411 of the input layer 410 are configured to receive, as input, initial weight matrices 321 corresponding to different initial prediction models 320. Unlike a conventional deep neural network where features are propagated from an input layer, the input layer 410 propagates the initial weight matrices 321 representing configurations of the different initial prediction models 320 for multiple target variable classification.

The output nodes 431 of the output layer 430 are configured to provide, as output, final weight matrices 371 corresponding to different final prediction models 370. Each final weight matrix 371 comprises adjusted or optimized weights for different parameters of a final prediction model 370.

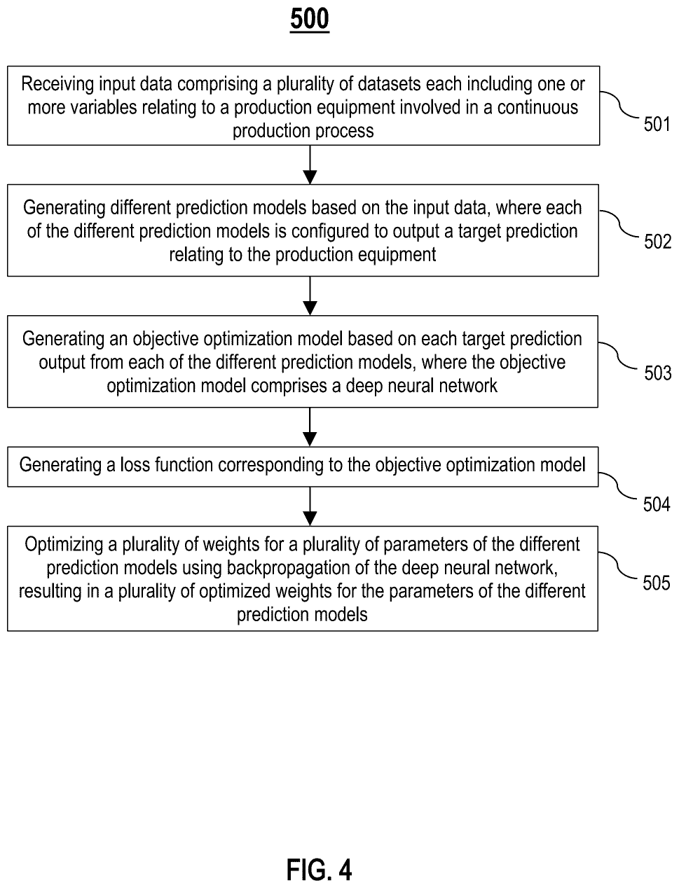

FIG. 4 is a flowchart for an example process 500 for optimization of a continuous production process, in accordance with an embodiment of the invention. Process block 501 includes receiving input data comprising a plurality of datasets each including one or more variables relating to a production equipment involved in the continuous production process. Process block 502 includes generating different prediction models (e.g., initial prediction models 320) based on the input data, where each of the different prediction models is configured to output a target prediction relating to the production equipment. Process block 503 includes generating an objective optimization model (e.g., objective optimization model 340) based on each target prediction output from each of the different prediction models, where the objective optimization model comprises a deep neural network (e.g., deep neural network 400). Process block 504 includes generating a loss function corresponding to the objective optimization model. Process block 505 includes optimizing a plurality of weights for a plurality of parameters of the different prediction models using backpropagation of the deep neural network, resulting in a plurality of optimized weights for the parameters of the different prediction models (e.g., final weight matrices 371 corresponding to different final prediction models 370).

In some embodiments, process blocks 501-505 are performed by one or more components of the system 300.

From the above description, it can be seen that embodiments of the invention provide a system, computer program product, and method for implementing the embodiments of the invention. Embodiments of the invention further provide a non-transitory computer-useable storage medium for implementing the embodiments of the invention. The non-transitory computer-useable storage medium has a computer-readable program, wherein the program upon being processed on a computer causes the computer to implement the steps of embodiments of the invention described herein. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. § 112(f), unless the element is expressly recited using the phrase “means for” or “step for.”

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimization of a continuous production process, comprising:
receiving input data comprising a plurality of datasets each including one or more variables relating to a production equipment involved in the continuous production process;
generating different prediction models based on the input data, wherein each of the different prediction models is configured to output a target prediction relating to the production equipment;
generating an objective optimization model based on each target prediction output from each of the different prediction models, wherein the objective optimization model comprises a deep neural network;
generating a loss function corresponding to the objective optimization model; and
optimizing a plurality of weights for a plurality of parameters of the different prediction models using backpropagation of the deep neural network and the loss function, resulting in a plurality of optimized weights for the parameters of the different prediction models.

2. The computer-implemented method of claim 1, further comprising:
splitting the datasets between a first group of datasets for training and a second group of datasets for testing;
defining a problem type for each of the different prediction models;
selecting a machine-learning algorithm for training each of the different prediction models; and
selecting one or more statistical measures for evaluating performance of each the different prediction models.

3. The computer-implemented method of claim 1, wherein the datasets include different variables with different time ranges that correspond to the different prediction models.

4. The computer-implemented method of claim 1, further comprising:
providing, as output, the optimized weights for the parameters of the different prediction models.

5. The computer-implemented method of claim 1, further comprising:
providing, as output, the different prediction models with fixed parameters based on the optimized weights.

6. The computer-implemented method of claim 1, further comprising:
generating an objective function corresponding to the objective optimization model, wherein the objective function represents one or more production optimization goals; and
generating constraints corresponding to the objective optimization model.

7. The computer-implemented method of claim 6, further comprising:
training the objective optimization model to minimize a difference quantified by the loss function, wherein the difference is between an expected objective value and a predicted objective value, the expected objective value is based on the objective function, and the predicted objective value is output from the objective optimization model.

8. The computer-implemented method of claim 1, wherein an input layer of the deep neural network propagates initial weight matrices representing configurations of the different prediction models.

9. A system for optimization of a continuous production process, comprising:
at least one processor; and
a processor-readable memory device storing instructions that when executed by the at least one processor causes the at least one processor to perform operations including:
receiving input data comprising a plurality of datasets each including one or more variables relating to a production equipment involved in the continuous production process;
generating different prediction models based on the input data, wherein each of the different prediction models is configured to output a target prediction relating to the production equipment;
generating an objective optimization model based on each target prediction output from each of the different prediction models, wherein the objective optimization model comprises a deep neural network;
generating a loss function corresponding to the objective optimization model; and
optimizing a plurality of weights for a plurality of parameters of the different prediction models using backpropagation of the deep neural network and the loss function, resulting in a plurality of optimized weights for the parameters of the different prediction models.

10. The system of claim 9, wherein the operations further include:
splitting the datasets between a first group of datasets for training and a second group of datasets for testing;
defining a problem type for each of the different prediction models;
selecting a machine-learning algorithm for training each of the different prediction models; and
selecting one or more statistical measures for evaluating performance of each the different prediction models.

11. The system of claim 9, wherein the datasets include different variables with different time ranges that correspond to the different prediction models.

12. The system of claim 9, wherein the operations further include:
providing, as output, the optimized weights for the parameters of the different prediction models.

13. The system of claim 9, wherein the operations further include:
providing, as output, the different prediction models with fixed parameters based on the optimized weights.

14. The system of claim 9, wherein the operations further include:
generating an objective function corresponding to the objective optimization model, wherein the objective function represents one or more production optimization goals; and
generating constraints corresponding to the objective optimization model.

15. The system of claim 14, wherein the operations further include:
training the objective optimization model to minimize a difference quantified by the loss function, wherein the difference is between an expected objective value and a predicted objective value, the expected objective value is based on the objective function, and the predicted objective value is output from the objective optimization model.

16. A computer program product for optimization of a continuous production process, the computer program product comprising a computer readable storage medium having program instructions embodied therewith, the program instructions executable by a processor to cause the processor to:
receive input data comprising a plurality of datasets each including one or more variables relating to a production equipment involved in the continuous production process;
generate different prediction models based on the input data, wherein each of the different prediction models is configured to output a target prediction relating to the production equipment;
generate an objective optimization model based on each target prediction output from each of the different prediction models, wherein the objective optimization model comprises a deep neural network;
generate a loss function corresponding to the objective optimization model; and
optimize a plurality of weights for a plurality of parameters of the different prediction models using backpropagation of the deep neural network and the loss function, resulting in a plurality of optimized weights for the parameters of the different prediction models.

17. The computer program product of claim 16, wherein the program instructions executable by the processor further cause the processor to:
split the datasets between a first group of datasets for training and a second group of datasets for testing;
define a problem type for each of the different prediction models;
select a machine-learning algorithm for training each of the different prediction models; and
select one or more statistical measures for evaluating performance of each the different prediction models.

18. The computer program product of claim 16, wherein the datasets include different variables with different time ranges that correspond to the different prediction models.

19. The computer program product of claim 16, wherein the program instructions executable by the processor further cause the processor to:
provide, as output, the optimized weights for the parameters of the different prediction models.

20. The computer program product of claim 16, wherein the program instructions executable by the processor further cause the processor to:
provide, as output, the different prediction models with fixed parameters based on the optimized weights.
